(19) United States
(12) Patent Application Publication
(10) Pub. No.: US 2010/0243976 A1
(43) Pub. Date: Sep. 30, 2010

(54) TEMPORARY RIGID STRUCTURE TO CONTROL THE FLOW OF PERSONS INTO THE ENTRY-WAY OF A VENUE

(75) Inventor: Kevin M. Crucs, Akron, OH (US)

Correspondence Address: HAHN LOESER & PARKS, LLP, One GOJO Plaza, Suite 300, AKRON, OH, 44311-1076, US

(73) Assignee: CRUCS HOLDINGS, LLC, Copley, OH (US)

(21) Appl. No.: 12/413,819

(22) Filed: Mar. 30, 2009

(51) Int. Cl. E04H 17/00; H04N 7/18

(52) U.S. Cl. 256/1; 348/143; 348/E07.085

(57) ABSTRACT

A temporarily modified entry way to a venue and a method of temporarily transforming an external entry way of a venue. A temporary rigid structure is erected outside of a venue such that the temporary rigid structure guides persons from at least one inlet of the structure to at least one exit of the structure through at least one passageway in a queued manner, where an exit of the structure is located at an entrance into the venue. The temporary rigid structure may be erected quickly for use and subsequently disassembled quickly when no longer needed.

### TECHNICAL FIELD

Certain embodiments of the present invention relate to crowd management. More particularly, certain embodiments relate to controlling the flow of persons into the entry-way of a venue via a temporary rigid structure.

### BACKGROUND

When a venue such as, for example, a department store has a sale or some other special event, people often congregate outside the venue before the venue opens for business, hoping to be one of the first into the venue to get the best deal, or to purchase a product before the venue runs out of that product. When the venue opens its doors for business, the congregating people may make a mad dash to the doors in a disorderly manner, subjecting each other to injury or even death, and causing damage to the entry-way of the venue.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

An embodiment of the present invention comprises a temporarily modified entry way to a venue. The modified entry way includes an external portion of a venue having at least a first entrance. The modified entry way also includes a first segment of a temporary rigid structure being external to the venue and having a first inlet, a first exit, and a first passageway between the first inlet and the first exit. The first exit is located at the first entrance of the venue, and the first segment is configured to guide persons from the first inlet, through the first passageway, to the first exit in a queued manner.

The modified entry way may further include a second segment of the temporary rigid structure being external to the venue and having a second inlet, a second exit, and a second passageway between the second inlet and the second exit. The second exit is located at a second entrance of the venue, and the second segment is configured to guide persons from the second inlet, through the second passageway, to the second exit in a queued manner.

The modified entry way may also include a third segment of the temporary rigid structure being external to the venue and having a third inlet, a third exit, and a third passageway between the third inlet and the third exit. The third exit is located at the third entrance of the venue, and the third segment is configured to guide persons from the third inlet, through the third passageway, to the third exit in a queued manner.

Another embodiment of the present invention comprises a method of temporarily transforming an external entry way of a venue. The method includes erecting a first segment of a temporary rigid structure external to the venue, where the first segment has a first inlet, a first exit, and a first passageway between the first inlet and the first exit. The first exit is located at a first entrance into the venue, and the first segment is configured to guide persons from the first inlet, through the first passageway, to the first exit in a queued manner.

The method may also include erecting a second segment of the temporary rigid structure external to the venue, where the second segment has a second inlet, a second exit, and a second passageway between the second inlet and the second exit. The second exit is located at a second entrance into the venue, and the second segment is configured to guide persons from the second inlet, through the second passageway, to the second exit in a queued manner.

The method may also include erecting a third segment of the temporary rigid structure external to the venue, where the third segment has a third inlet, a third exit, and a third passageway between the third inlet and the third exit. The third exit is located at a third entrance into the venue, and the third segment is configured to guide persons from the third inlet, through the third passageway, to the third exit in a queued manner. The method may further include disassembling the first segment of the temporary rigid structure. The method may also include disassembling the second segment of the temporary rigid structure. The method may further include disassembling the third segment of the temporary rigid structure.

The first entrance of the venue and the first segment of the temporary rigid structure may be associated with a first particular product desired to be purchased from the venue. Similarly, the second entrance of the venue and the second segment of the temporary rigid structure may be associated with a second particular product desired to be purchased from the venue, and the third entrance of the venue and the third segment of the temporary rigid structure may be associated with a third particular product desired to be purchased from the venue.

The temporary rigid structure may be configured from metal members such as, for example, aluminum members. The members may have quick-connect/quick-disconnect mechanisms capable of allowing the members to be quickly assembled into the temporary rigid structure and later quickly disassembled. In accordance with one embodiment, the temporary rigid structure rests on a walking surface external to the venue. In accordance with another embodiment, the temporary rigid structure is temporarily secured to a walking surface external to the venue.

A cover may be provided that is capable of being fastened to the temporary rigid structure, for example, to protect persons from rain and snow. Video surveillance equipment may be provided to monitor persons entering and exiting the temporary rigid structure. Furthermore, at least one of television video screen, advertisements, and audio speakers may be mounted to the temporary rigid structure to provide television programming, music, or information to the persons standing within the temporary rigid structure. Also, a counting system may be provided that is capable of counting a number of persons entering the venue and capable of counting a number of persons exiting the venue.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates an example of a first embodiment of a temporarily modified entry-way to a venue having a temporary rigid structure;

FIG. 2 illustrates an example of an embodiment of a linear section of the temporary rigid structure of the temporarily modified entry-way of FIG. 1;

FIG. 3 illustrates the linear section of FIG. 2 of the temporary rigid structure of FIG. 1 guiding persons towards an entrance of the venue of FIG. 1;

FIG. 4 illustrates two linear sections of FIG. 2 and how the two linear sections are connected to form a portion of the temporary rigid structure of FIG. 1;

FIG. 5 illustrates the linear section of FIG. 2 connecting to an example of an embodiment of a corner section of the temporary rigid structure of FIG. 1;

FIG. 6 illustrates the corner section of FIG. 5 connected between two linear sections of FIG. 2 to form a turning portion of the temporary rigid structure of FIG. 1;

FIG. 7 illustrates an example of a second embodiment of a temporarily modified entry-way to a venue having a temporary rigid structure.

### DETAILED DESCRIPTION

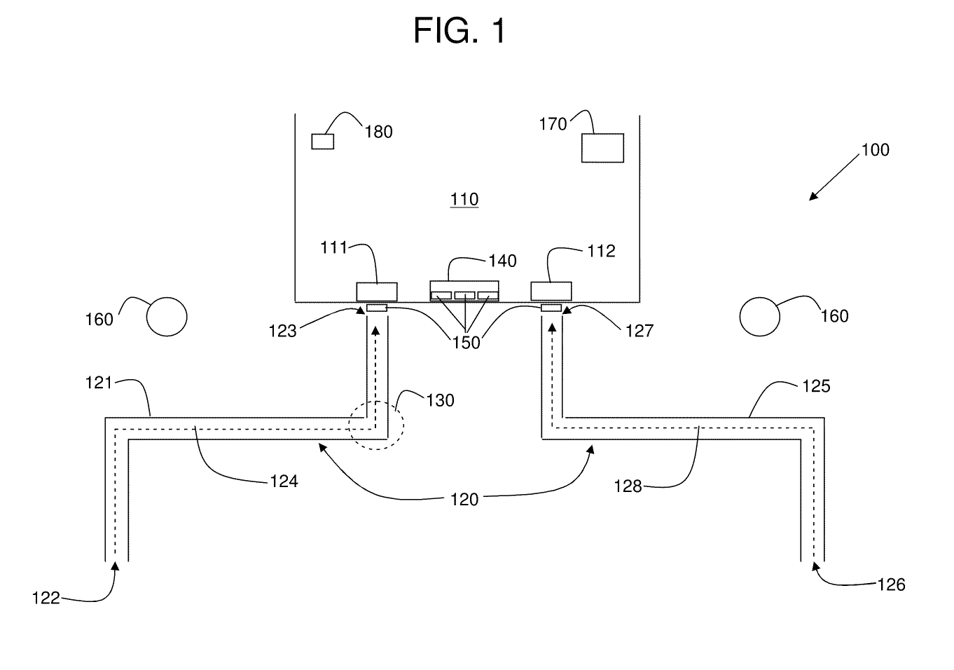

FIG. 1 illustrates an example of an embodiment of a temporarily modified entry-way 100 to a venue 110 having a temporary rigid structure 120. The venue may be, for example, a store that sells products, a concert hall, or any other type of venue where a large number of people may have reason to congregate before entering the venue 110. The venue 110 includes a first entrance 111 and a second entrance 112. The venue 110 may further include a one-way exit 140 to prevent people from trying to rush into the venue 110 using the exit doors. The one-way exit 140 allows people, with their purchases, to easily exit the venue 110 and allows mass exiting in case of an emergency. However, the one-way exit 140 includes doors configured to prevent people from entering the venue 110 through the exit 140.

The temporary rigid structure 120 is erected externally to the venue 110 (e.g., in front of the venue) and includes a first segment 121 and a second segment 125. The first segment 121 and the second segment 125 are each single level segments (i.e., the segments do not provide multiple levels of use as scaffolding may provide). The first segment 121 provides a first inlet 122, a first exit 123, and a first passageway 124 between the first inlet 122 and the first exit 123. The first exit 123 is located at the first entrance 111 of the venue 110. The first segment 121 is configured to guide persons from the first inlet 122, through the first passageway 124, and to the first exit 123 in a queued manner toward the first entrance 111 of the venue 110.

Similarly, the second segment 125 provides a second inlet 126, a second exit 127, and a second passageway 128 between the second inlet 126 and the second exit 127. The second exit 127 is located at the second entrance 112 of the venue 110. The second segment 125 is configured to guide persons from the second inlet 126, through the second passageway 128, and to the second exit 127 in a queued manner toward the second entrance 112 of the venue 110. In accordance with other embodiments of the present invention, the venue may include additional entrances having additional segments of a temporary rigid structure leading to those entrances.

The temporary rigid structure 120 may be configured from metal members such as, for example, aluminum members. In accordance with other embodiments, the members may be wood, bamboo, plastic, or some other rigid material, for example. The members may have quick-connect/quick-disconnect mechanisms capable of allowing the members to be quickly assembled into the temporary rigid structure 120, and then later quickly disassembled. Such quick-connect/quick-disconnect mechanisms are well known in the art.

In accordance with one embodiment, the temporary rigid structure rests on a walking surface external to the venue 110. The walking surface may be, for example, an asphalt surface extending into a parking lot. Weights may be applied to the temporary rigid structure 120 to help keep the temporary rigid structure 120 in place during use. In accordance with another embodiment, the temporary rigid structure is temporarily secured to a walking surface external to the venue 110. For example, the temporary rigid structure 120 may be temporarily secured to a walking surface in front of the venue 110 via a temporary adhesive or teeth on a bottom portion of the temporary rigid structure that comes into contact with the walking surface.

In accordance with an embodiment of the present invention, the first entrance 111 of the venue 110 and the first segment 121 of the temporary rigid structure 120 is associated with a first particular product desired to be purchased from the venue 110. Similarly, the second entrance 112 of the venue 110 and the second segment 125 of the temporary rigid structure 120 is associated with a second particular product desired to be purchased from the venue 110.

For example, the venue 110 may be a store that will be selling two very desirable products that have just come onto the market. The first product may be an electronic book and the second product may be a game console, for example. On the day that the store will first offer the two products for sale, a large crowd of people is anticipated to gather outside of the front of the store early in the morning before the store opens. As a result, the store manager hires a firm to erect the temporary rigid structure 120 the night before as shown in FIG. 1.

The first segment 121 and the first entrance are designated for persons to queue up for the electronic book. The second segment 125 and the second entrance are designated for persons to queue up for the game console. As a result, the temporary rigid structure 120 will serve to control and organize the anticipated crowd of people, helping to avoid a rush of people to the entrances and, therefore, possible injuries or deaths. The rigid structure 120 is rigid and secure enough to handle the crowd of people, yet may be set up (assembled) quickly and easily by a team of assemblers. Furthermore, since the rigid structure 120 is temporary, the rigid structure 120 may be quickly and easily taken down (dis-assembled) later in the day when the crowd has diminished.

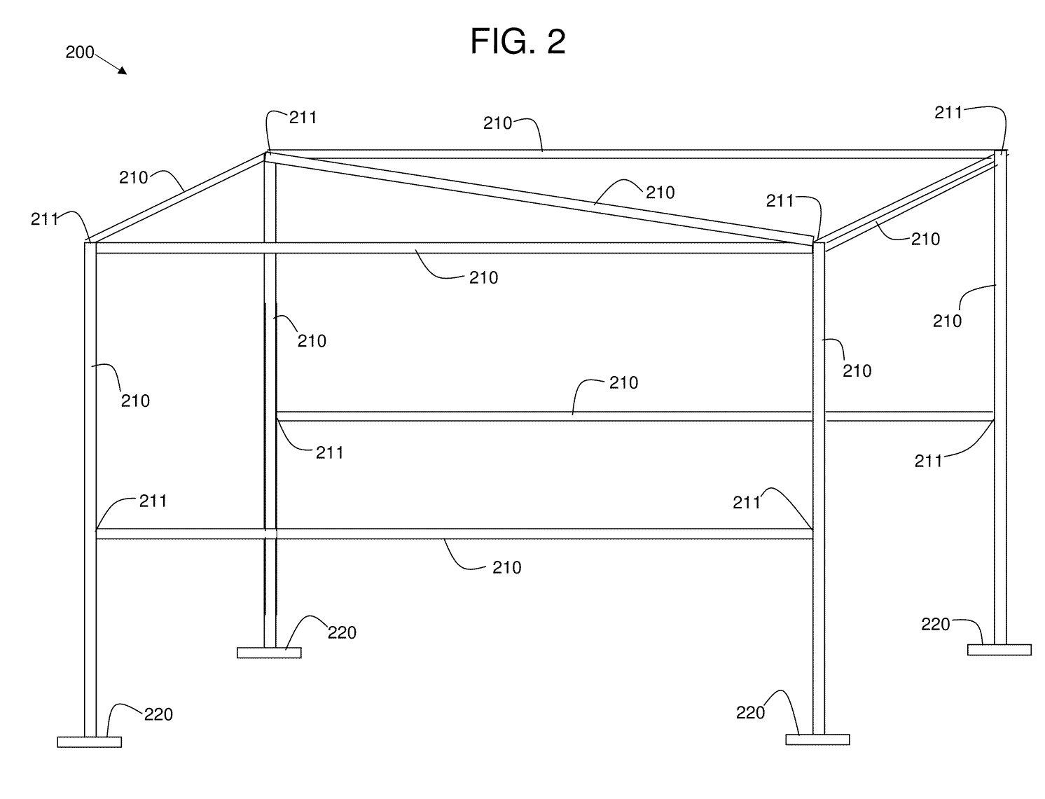

FIG. 2 illustrates an example of an embodiment of a linear section 200 of the temporary rigid structure 120 of the temporarily modified entry-way 100 of FIG. 1. The segments 121 and 125 may be made up of such linear sections 200, at least in part. The linear section 200 includes a plurality of members 210 connected together at connection points 211. The connection points 211 may include quick-connect/quick-disconnect mechanisms to allow the members 210 to be quickly assembled and disassembled. An example of such quick-connect/quick-disconnect mechanisms may include slide-thorugh bolts and cotter pins, which are well known in the art. Another example of such quick-connect/quick-disconnect mechanisms may include snap-together joints, which are also well known in the art. Other quick-connect/quick-disconnect mechanisms are possible as well.

The linear section 200 may also include feet members 220. The feet members 220 are intended to rest on a surface external to the venue 110 and function to support the members 210. The bottom portions of the feet members 220 may include teeth to grab or slightly dig into a walking surface (e.g., asphalt). As an alternative, the bottom portions of the feet members 220 may have an adhesive applied to allow the feet members 220 to temporarily adhere to the walking surface.

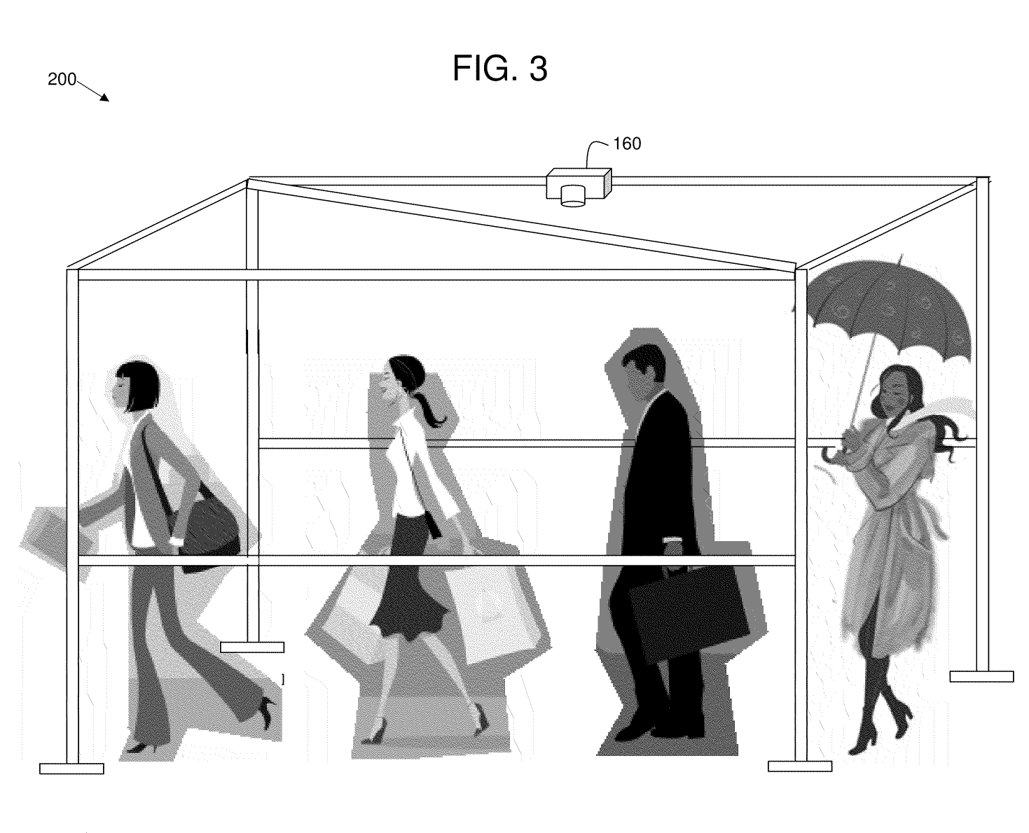

The linear section 200 may be used to form a portion of the temporary rigid structure 120 of FIG. 1 to guide persons toward an entrance of the venue 110. FIG. 3 illustrates the linear section 200 of FIG. 2 of the temporary rigid structure 120 of FIG. 1 guiding persons towards an entrance of the venue 110 of FIG. 1. The persons walk along a portion of the passageway formed by the linear structure 200 guided by the various members 210. The linear members provide guidance to the persons using the temporary rigid structure 120 as well as rigid support to the temporary rigid structure 120.

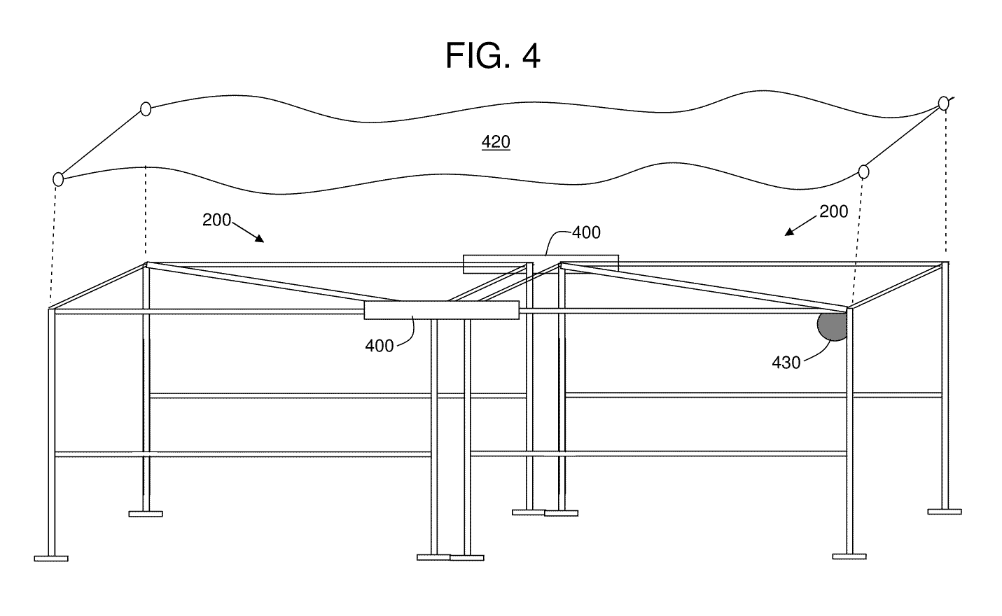

FIG. 4 illustrates two linear sections 200 of FIG. 2 and how the two linear sections 200 are connected to form a portion of the temporary rigid structure 120 of FIG. 1. In FIG. 4, the two linear sections 200 are connected to each other by connecting members 400. The connecting members 400 connect to the two linear sections 200 near the top portion of the two linear sections 200 as shown in FIG. 4. The connecting members 400 may include, for example, flat plates having quick-connect/quick-disconnect mechanisms such as clamps that may be readily clamped onto the members 210.

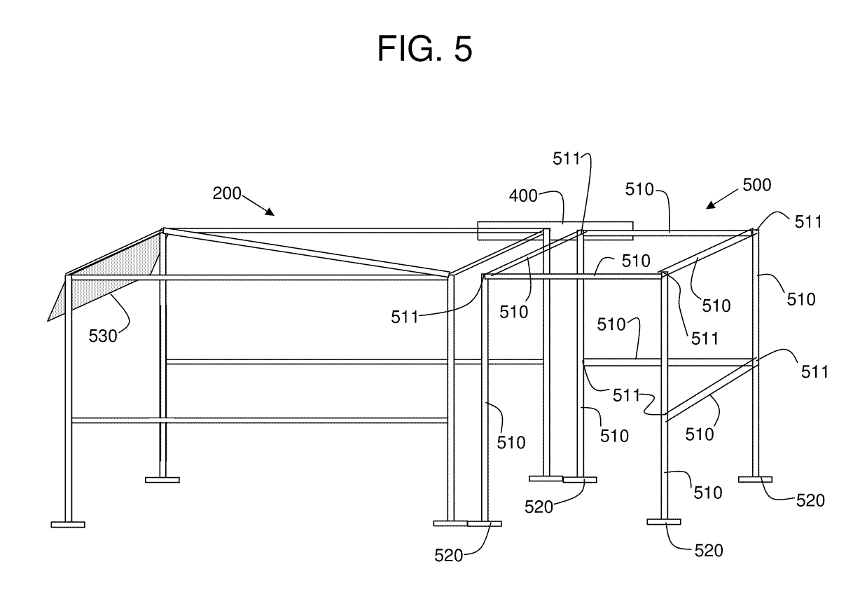

FIG. 5 illustrates the linear section 200 of FIG. 2 connecting to an example of an embodiment of a corner section 500 of the temporary rigid structure 120 of FIG. 1. The corner section 500 includes a plurality of members 510 connected together at connection points 511. The connection points 511 may include quick-connect/quick-disconnect mechanisms to allow the members 510 to be quickly assembled and disassembled. The corner section 500 may also include feet members 520. The feet members 520 are intended to rest on a surface external to the venue 110 and function to support the members 510. The corner section 500 may be used to form a corner portion of the temporary rigid structure 120 of FIG. 1 to guide persons around a corner of the temporary rigid structure 120 and toward an entrance of the venue 110. For example, a person may enter the corner section 500 and then be guided by the members 510 to make an immediate left into the linear section 200.

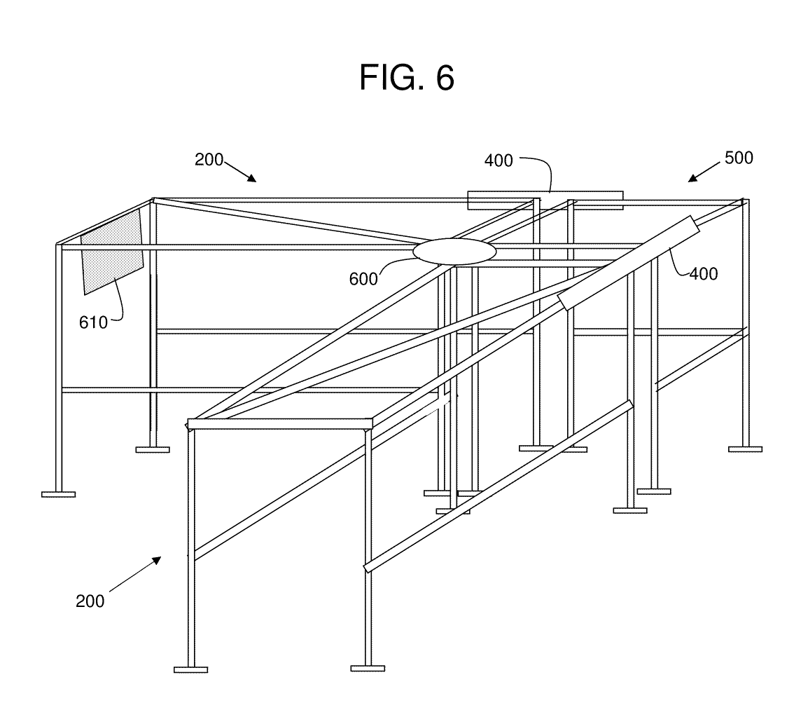

FIG. 6 illustrates the corner section 500 of FIG. 5 connected between two linear sections 200 of FIG. 2 to form a turning portion 130 (see FIG. 1) of the temporary rigid structure 120 of FIG. 1. The two linear sections 200 and the corner section 500 form a right angle as shown in FIG. 5. The sections may be connected using connecting members 400 and 600. The connecting member 600 may be a special connecting member used just at corner connections. The connecting member 600 may include, for example, a flat plate having quick-connect/quick-disconnect mechanisms such as clamps that may be readily clamped onto the members 210 and 510.

In accordance with an embodiment of the present invention, the temporary rigid structure 120 may be fitted with a covering 420 to help keep out inclement weather such as rain and snow. Such a covering 420 may be made of a flexible plastic material (e.g., a tarp) and fastened to the various members of the temporary rigid structure 120 via, for example, tied ropes.

In accordance with another embodiment of the present invention, the temporarily modified entry-way 100 is fitted with video surveillance equipment. The video surveillance equipment may include one or more video cameras 160 mounted on tripods in proximity to the temporary rigid structure 120 in order to monitor persons entering and exiting the temporary rigid structure 120, as well as persons within the temporary rigid structure. In accordance with certain embodiments, the video cameras 160 may be mounted on the temporary rigid structure 120. Video data may be transmitted (via wire, or wirelessly) to a video monitoring station 170 within the venue 110 or within a vehicle positioned proximate to the venue 110. Such video surveillance equipment and methods of mounting are well known.

In accordance with a further embodiment of the present invention, television video screens 610, advertisements 530, audio speakers 430, or any combination thereof may be mounted on the temporary rigid structure 120 to provide television programming, music, or information to the persons standing within the temporary rigid structure 120 while they wait to get to the entrance 111 or 112 of the venue 110. Such video screens, advertisements, or audio speakers may be temporarily mounted, in a secured manner, to the various members of the rigid structure 120. Such methods of mounting are well known.

In accordance with another embodiment of the present invention, the temporarily modified entry-way 100 may include a temporary counting system capable of counting a number of persons that have entered the venue 110 and a number of persons that have exited the venue. The counting system may calculate a net number of persons within the venue 110 by subtracting the number of persons that have left the venue 110 from the number of persons that have entered the venue 110. Such a net number may be used to maintain a cut-off level if the venue has an occupancy limit, or may simply be used to manage the number of persons within the venue 110 based on how many persons can be serviced over a particular period of time. For example, if a cut-off limit is reached (i.e., a maximum number of persons are within the venue), the entrances 111 and 112 may be manually or automatically closed until the net number of persons within the venue drops below the cut-off limit.

In accordance with an embodiment of the present invention, the temporary counting system may include revolving gates or turnstiles 150 positioned between the exits 123, 127 and the corresponding entrances 111, 112, and positioned at the one-way exit 140. Each of the revolving gates 150 may automatically report out a current count of persons that have passed through each of the revolving gates. Such reporting out may be accomplished by wireless means to a personal computer 180, for example. The personal computer 180 may be used to constantly or periodically calculate a net number of persons within the venue 110.

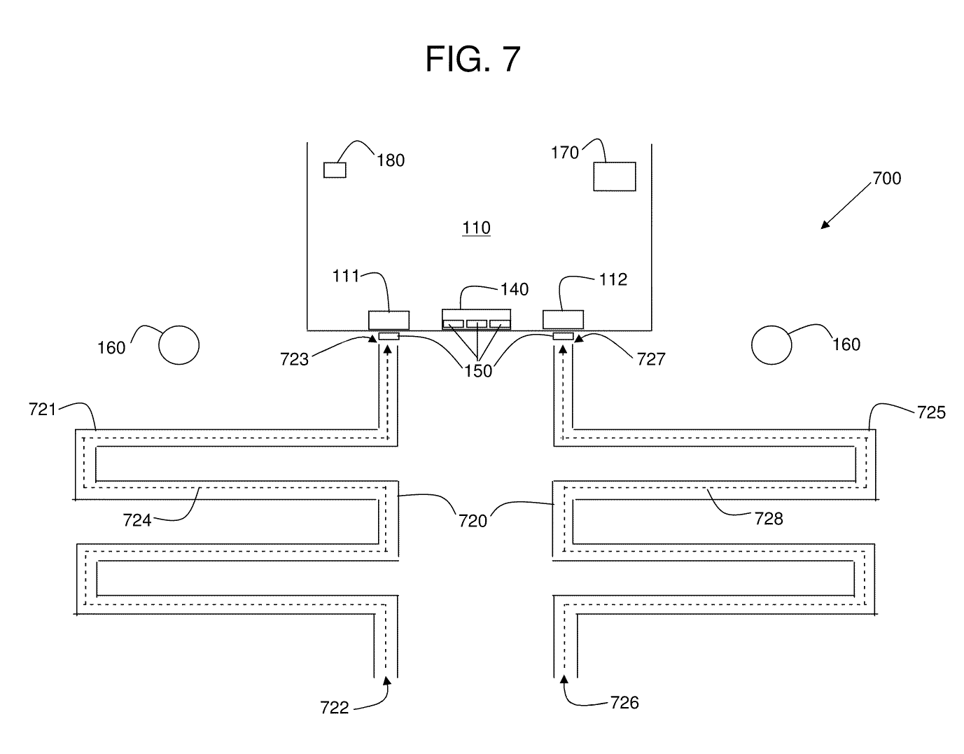

FIG. 7 illustrates an example of a second embodiment of a temporarily modified entry-way 700 to a venue 110 having a temporary rigid structure 720. The temporarily modified entry-way 700 is similar to the temporarily modified entry-way 100 of FIG. 1 except that the temporary rigid structure 720 is configured in a zig-zag or back and forth arrangement in an attempt to accommodate more persons or to make better use of space external to the venue 110.

The temporary rigid structure 720 is erected externally to the venue 110 (e.g., in front of the venue) and includes a first segment 721 and a second segment 725. The first segment 721 and the second segment 725 are each single level segments (i.e., the segments do not provide multiple levels of use as scaffolding may provide). The first segment 721 provides a first inlet 722, a first exit 723, and a first passageway 724 between the first inlet 722 and the first exit 723. The first exit 723 is located at the first entrance 111 of the venue 110. The first segment 721 is configured to guide persons from the first inlet 722, through the first passageway 724, and to the first exit 723 in a queued, zig-zag manner toward the first entrance 111 of the venue 110.

Similarly, the second segment 725 provides a second inlet 726, a second exit 727, and a second passageway 728 between the second inlet 726 and the second exit 727. The second exit 727 is located at the second entrance 112 of the venue 110. The second segment 725 is configured to guide persons from the second inlet 726, through the second passageway 728, and to the second exit 727 in a queued, zig-zag manner toward the second entrance 112 of the venue 110. In accordance with other embodiments of the present invention, the venue may include additional entrances having additional segments of a temporary rigid structure leading to those entrances.

In summary, a temporarily modified entry way to a venue and a method of temporarily transforming an external entry way of a venue are disclosed. A temporary rigid structure is erected outside of a venue such that the temporary rigid structure guides persons from at least one inlet of the structure to at least one exit of the structure through at least one passageway in a queued manner, where an exit of the structure is located at an entrance into the venue. The temporary rigid structure may be erected quickly for use and subsequently disassembled quickly when no longer needed.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A temporarily modified entry way to a venue, said modified entry way comprising:
an external portion of a venue having at least a first entrance; and
a first segment of a temporary rigid structure being external to said venue and having a first inlet, a first exit, and a first passageway between said first inlet and said first exit, where said first exit is located at said first entrance of said venue, and where said first segment is configured to guide persons from said first inlet, through said first passageway, to said first exit in a queued manner.

2. The modified entry way of claim 1, further comprising a second segment of said temporary rigid structure being external to said venue and having a second inlet, a second exit, and a second passageway between said second inlet and said second exit, where said second exit is located at a second entrance of said venue, and where said second segment is configured to guide persons from said second inlet, through said second passageway, to said second exit in a queued manner.

3. The modified entry way of claim 2, further comprising a third segment of said temporary rigid structure being external to said venue and having a third inlet, a third exit, and a third passageway between said third inlet and said third exit, where said third exit is located at a third entrance of said venue, and where said third segment is configured to guide persons from said third inlet, through said third passageway, to said third exit in a queued manner.

4. The modified entry way of claim 1 wherein said temporary rigid structure is configured from metal members.

5. The modified entry way of claim 1 wherein said temporary rigid structure is configured from aluminum members.

6. The modified entry way of claim 1 wherein said temporary rigid structure is configured from members having quick-connect/quick-disconnect mechanisms.

7. The modified entry way of claim 1 wherein said temporary rigid structure rests on a walking surface external to said venue.

8. The modified entry way of claim 1 wherein said temporary rigid structure is temporarily secured to a walking surface external to said venue.

9. The modified entry way of claim 1 whereby said first entrance of said venue and said first segment of said temporary rigid structure is associated with a first particular product desired to be purchased from said venue.

10. The modified entry way of claim 2 whereby said second entrance of said venue and said second segment of said temporary rigid structure is associated with a second particular product desired to be purchased from said venue.

11. The modified entry way of claim 3 whereby said third entrance of said venue and said third segment of said temporary rigid structure is associated with a third particular product desired to be purchased from said venue.

12. The modified entry way of claim 1 further comprising a covering capable of being fastened to said temporary rigid structure.

13. The modified entry way of claim 1 further comprising video surveillance equipment.

14. The modified entry way of claim 1 further comprising at least one of television video screens, advertisements, and audio speakers mounted to said temporary rigid structure.

15. The modified entry way of claim 1 further comprising a counting system capable of counting a number of persons entering said venue and capable of counting a number of persons exiting said venue.

16. A method of temporarily transforming an external entry way of a venue, said method comprising:
erecting a first segment of a temporary rigid structure external to said venue, where said first segment has a first inlet, a first exit, and a first passageway between said first inlet and said first exit, and where said first exit is located at a first entrance into said venue, and where said first segment is configured to guide persons from said first inlet, through said first passageway, to said first exit in a queued manner.

17. The method of claim 16, further comprising erecting a second segment of said temporary rigid structure external to said venue, where said second segment has a second inlet, a second exit, and a second passageway between said second inlet and said second exit, and where said second exit is located at a second entrance into said venue, and where said second segment is configured to guide persons from said second inlet, through said second passageway, to said second exit in a queued manner.

18. The method of claim 17, further comprising erecting a third segment of said temporary rigid structure external to said venue, where said third segment has a third inlet, a third exit, and a third passageway between said third inlet and said third exit, and where said third exit is located at a third entrance into said venue, and where said third segment is configured to guide persons from said third inlet, through said third passageway, to said third exit in a queued manner.

19. The method of claim 16 wherein said temporary rigid structure is configured from metal members.

20. The method of claim 16 wherein said temporary rigid structure is configured from aluminum members.

21. The method of claim 16 wherein said temporary rigid structure is configured from members having quick-connect/quick-disconnect mechanisms.

22. The method of claim 16 wherein said temporary rigid structure rests on a walking surface external to said venue.

23. The method of claim 16 further comprising temporarily securing said temporary rigid structure to a walking surface external to said venue.

24. The method of claim 16 further comprising disassembling said first segment of said temporary rigid structure.

25. The method of claim 17 further comprising disassembling said second segment of said temporary rigid structure.

26. The method of claim 18 further comprising disassembling said third segment of said temporary rigid structure.

27. The method of claim 16 further comprising temporarily fastening a covering to said temporary rigid structure.

28. The method of claim 16 further comprising temporarily installing video surveillance equipment capable of monitoring persons entering and exiting said temporary rigid structure.

29. The method of claim 16 further comprising temporarily mounting at least one of television video screens, advertisements, and audio speaker to said temporary rigid structure.

30. The method of claim 16 further comprising temporarily installing a counting system capable of counting a number of persons entering said venue and capable of counting a number of persons exiting said venue.
